(19) United States
(12) Patent Application Publication
(10) Pub. No.: US 2025/0064087 A1
(43) Pub. Date: Feb. 27, 2025

(54) MEAT AND SEAFOOD ANALOGUE PRODUCTS

(71) Applicants: BK GIULINI GMBH, LADENBURG (DE); Plantible Foods Inc.

(72) Inventors: Sathaporn SRICHUWONG, HEIDELBERG (DE); Alexander GRABER, MANNHEIM (DE); Martin LOEW, EDINGEN - NECKARHAUSEN (DE); Radovan SPORKA, HEIDELBERG (DE); Tony MARTENS, SAN MARCOS, CA (US); Parker LEE, POWAY, CA (US)

(21) Appl. No.: 18/725,224

(22) PCT Filed: Dec. 30, 2022
(86) PCT No.: PCT/EP2022/088080

§ 371 Date: Jun. 28, 2024

Related U.S. Application Data
(60) Provisional application No. 63/333,168, filed on Apr. 21, 2022.

(30) Foreign Application Priority Data
Dec. 30, 2021 (EP) 21218409.7

(51) Int. Cl. A23J 3/22; A23J 3/14; A23L 29/212; A23L 29/281

(52) U.S. Cl. CPC A23J 3/227; A23J 3/14; A23L 29/212; A23L 29/281

(57) ABSTRACT

The present invention relates to a plant-based meat substitute comprising (i) particles comprising a texturized plant protein material, water and a vegetable lipid and (ii) a binding agent comprising, relative to the particles and binding agent,—0.5% to 20% of a high gel strength protein−0.3% to 20% of a cold-thickening polysaccharide

### FIELD OF THE INVENTION

This invention relates to meat and seafood analogue products containing a combination of texturized protein particles and a binding agent, and to a process for making this analogue product.

### BACKGROUND

Because of environmental and health concerns, consumers are increasingly trying to limit the amount of meat and other animal-based foods in their diets. Therefore, there is increasing demand for meat analogues comprising solely vegetable or non-animal derived ingredients. Consumers expect that the meat analogues should have similar taste, appearance, odor, texture, nutrient profile, response to heating, and mechanical and rheological properties to the meat product counterparts.

For this reason, plant-based proteins and other non-animal derived ingredients are used in manufacturing meat analogues to optimize nutritional and textural properties of final products to meet consumer expectations. Currently, a number of commercial meat and seafood substitutes, such as plant-based burger patties, meatballs, crab cakes, fish fingers, nuggets, and related products, have been developed based on combinations of plant-based proteins and chemically modified food additives. To meet consumer expectations, it is known that several ingredients and food additives, such as plant-based proteins, binding agent, stabilizer, coloring agent, flavouring agent, are required to optimize nutritional and textural properties to mimic those of conventional meat product counterparts.

WO 2020/038541, for example, describes exclusively plant-based meat substitutes. Such plant-based meat substitutes are currently being manufactured for instance from plant proteins obtained from nuts, legumes, or various cereals, and oligosaccharides and lipids. For plant-based ground meat substitutes, such as burger patty, meatballs, taco meat, and similar products, texturized plant protein material or texturized vegetable protein (abbreviated as TVP) produced by low-moisture extrusion cooking are commonly used to mimic ground meat muscle textures, for instance the brand Rovitaris® PX 365, a TVP based on pea-protein. Other types of TVP having higher liquid content and more fibrous layer structure can be manufactured by high moisture extrusion cooking of plant-based proteins or co-precipitation of plant-based proteins and alginate in connection with a source of calcium chloride. Such high moisture TVP may possess off-white color which is more suitable for preparation of plant-based chicken substitutes such as chicken nuggets, and plant-based seafoods substitutes such as crab cake, fish stick products-. Commercial TVP can be made for example from soy protein, pea protein and wheat gluten. Soy protein and wheat gluten are listed as allergen-containing food ingredients, therefore pea-protein based TVP has increases its popularity and is currently the main source of allergen-free TVP product. However pea-based TVP has far inferior protein quality especially the amount of essential amino acids in comparison to animal-derived proteins such as egg white and dairy proteins. Food manufacturers are trying to increase the amount of total essential amino acids of pea-based TVP meat analogues by incorporation of more nutritious food proteins however this approach commonly leads to inferior textural profile of the products.

A binder or binding agent is essential to attain the desired mechanical strength and texture, and to maintain the shape of the given meat and seafood substitutes. A binding agent is a single edible food substance or a mixture of edible food substances that are added to thicken or hold components of the foodstuff through one or more of thickening, dispersing and gelation properties. One particularly preferred binder for ground meat substitutes, such as plant-based burgers, patties, meat balls, chicken nuggets, fish fingers or crab cakes is methylcellulose.

Unlike other food substances, methylcellulose possesses unique properties i.e. (i) cold binding through thickening water-based liquid (inclusion of methylcellulose emulsion enables shaping or molding a hydrated mixture of TVP particles and other ingredients to desired shapes); and (ii) hot binding through a formation of thermal reversible gel upon heating (which provides texture and integrity for hot consumption). However, methylcellulose gel melts upon cooling resulting in viscosity reduction which would affect quality of some products. In vegetarian products, a gelling protein such as egg white is commonly used for hot binding. Unlike methylcellulose, a gel of egg white protein does not melt during cooling. Furthermore, a disadvantage of using methylcellulose is, that its processing includes an additional step of pre-emulsification using high shear equipment at low temperature prior to usage.

In ground meat and seafood substitute products, the use of binders is unavoidable to provide adhesion for the TVP particles and other ingredients. These binding agents can also provide for emulsion stability to prevent the leakage of oil, and for mechanical stability during further processing, transport, or optional storage. In addition to methylcellulose, the functionality of hydroxypropyl methylcellulose, wheat gluten, corn zein and alginates, to bind TVP, improve oil encapsulation and reduce oil absorption, is well documented. Other texturizing agents include, for example, the dietary fibres, fibre-rich fractions of cereals, hydrocolloids, and plant protein concentrates or isolates (e.g. soy, pea and other plant sources). These texturizing agents may be added to further improve water retention and overall textural property of the meat and seafood substitutes products.

WO2020/089445, for example, describes a process for making a meat analogue that is substantially free of hydrocolloids or chemically modified starches. EP-A-3944769 describes potato protein based binding systems.

The global clean-label trend among food producers and consumers leads to the desire to have less chemically sounding or highly processed substances on the ingredient list. Several chemically modified food additives are number coded according to the International Numbering System for Food Additives (INS) or E-number according to European Union while simple ingredients such as protein materials, physically modified starches, and plant fiber materials are classified as ingredients instead of additives, and therefore do not carry an INS number. Methylcellulose is synthesized by chemical modification, namely etherification, of cellulose resulting in methyl groups (−CH3) substitution for the hydroxyl groups at C-2, C-3 and/or C-6 positions of anhydro-D-glucose units. The etherification process involves several chemicals such chloromethane, iodomethane or dimethyl sulfate. Accordingly, methylcellulose is commonly perceived as chemically modified or highly processed ingredient. It is coded as European food additive number E461. Many formulators are therefore seeking alternatives that provide the same functionality as methylcellulose, while offering a cleaner label aspect. Label friendly ingredients may generally include any ingredients derived from natural sources with mild processing methods, or more recognizable and familiar to consumers, or not categorized as synthetic food additives, and non-GMO etc. Despite this demand, existing solutions are not sufficient to replace methylcellulose due to its unique cold and hot binding properties.

A comprehensive review on plant-based meat substitutes has recently been published (Kyriakopoulou et al., Functionality of Ingredients and Additives in Plant-based Meat Analogues, Foods 2021, 10, 600). The review also states that up to the present point no clear alternative to methylcellulose would exist that provides all necessary functionalities.

### SUMMARY OF THE INVENTION

This invention provides a label-friendly binding system, suitable for the manufacture of plant-based meat and seafood substitutes. This invention also provides purely plant-based meat substitutes devoid of methylcellulose.

The plant-based meat substitute according to the present invention comprises
(i) particles comprising a texturized plant protein material, water and a vegetable lipid and
(ii) a binding agent comprising, relative to the particles and binding agent,
   0.5% to 20% of a high gel strength protein
   0.3% to 20% of a cold-thickening polysaccharide

The binding system according to the invention is able to mimic the unique behavior of methylcellulose during processing of meat substitutes, namely creating necessary cold viscosity and adhesion of components, like TVP particles, during the shaping process and gelling upon heating, thereby creating the required succulence and consistency needed to create a meat substitute product that intends to represent texture of conventional meat products.

The binding system according the invention furthermore, shows improved properties compared to methylcellulose: The texture, measured as total hardness, representing sensory impression during mastication, is maintained during cooling down of respective meat substitute products. This property is advantageous when producing preprocessed ready-to-eat variants, for example, ready-to-eat burgers available in the cooling fridge of retail markets. Food manufacturers using the new binding system are able to design consistency parameters, like for example softness of the product, without having to take into consideration viscosity changes during (re) heating by the consumer.

Furthermore, the binding system according the invention shows improved nutritional properties of meat or seafood substitutes compared to methylcellulose, namely increased total protein content and increased total protein quality, measured as greater amount of essential amino acids. Food manufacturers using the new binding system are able to increase overall nutritional values of the meat substitute products, especially wherein inferior protein sources such as pea protein and wheat gluten are used as TVP bulk particles.

Furthermore, the binding system of the present invention shows improved process handling and energy saving in manufacturing meat or seafood substitutes compared to methylcellulose. When using methylcellulose as binding agent two separated preparation steps are typically required for maximum performance. Hydration and mixing of methylcellulose in water and fat or oil at low temperature (<5° C.), to create a viscous homogeneous mass (emulsion) takes place in a step separate from the preparation of a mixture of the remaining ingredients including protein, which is then followed by combining the methylcellulose emulsion with the other components. The present invention allows for a single-step preparation, as the new binding system, in contrast to methylcellulose, can be mixed together with all other ingredients required for preparation of a meat substitute in dry form and still be sufficiently hydrated when water is added or when adding to hydrated TVP. One major advantage resulting therefrom is reduction of processing effort, namely saving of equipment, time and cost. In addition, ingredient suppliers may now offer combined solutions in one packaging with all dry ingredients that are required for manufacture of vegan meat substitutes.

Preferably, the plant-based meat substitute comprises particles (i) comprising 10 wt % to 60 wt % of texturized plant protein material, 10% to 90% of water and 1% to 30% of a vegetable lipid, wherein the wt % are related to the plant-based meat substitute (amounts of (i) and (ii)).

Preferably, the binding agent of the plant-based meat substitute of the invention comprises 0.5-8% of a high gel strength protein, more preferably 1-6 wt %.

Preferably, the binding agent of the plant-based meat substitute of the invention comprises 0.5-6% of a cold-thickening polysaccharide, more preferably 0.5-4 wt %.

Preferably, the high gel strength protein of the plant-based meat substitute according to the invention includes Rubisco (ribulose-1,5-bisphosphate carboxylase-oxygenase) protein isolates or concentrates from plant materials or algae; and protein isolates or concentrates from potato, canola or other protein sources possessing specific characteristics, wherein gel hardness values at least 30 g at 4 wt % concentration in demineralized water, or in water with 1.5 wt % sodium chloride, preferably at 4 wt % concentration in demineralized water and in water with 1.5 wt % sodium chloride; and preferably having—as a 2 wt % protein-a solubility in water and in 1.5 wt % NaCl of more than 40%, preferably more than 50%.

Rubisco is a soluble protein naturally found in plant green leaves or algae. Preferably, Rubisco protein in the invention is extracted and purified from an aquatic plant material such as Lemnoideae which is commonly known as duckweeds, water lentils or water lenses. in WO 2021/007484 describes an effective production technology to produce Rubisco from Lemna or Lemnoideae. Alternatively, Rubisco can be produced from other plant leaf materials like spinach, sugar beet leaf or tobacco leaf.

Preferably, the cold thickening polysaccharide in the plant-based meat substitute of the invention includes physically modified starches, namely pregelatinized or cold water-swelling starches, plant fiber materials (e.g. instant oatmeal, psyllium husk fiber), and/or soluble fibers (e.g. beta-glucan, arabinoxylan, pectin). The cold thickening polysaccharide in the invention can be single material, or a mixture of the described food substances that provide cold thickening ability without heating treatment. More preferably, in the present invention, one or more of physically modified starches or plant fiber materials is used as a cold thickening polysaccharide due to their label-friendly aspect.

Preferably, the binding agent of the plant-based meat substitute of the invention comprises Rubisco protein as the high gel strength protein, and pregelatinized pea starch as the cold thickening polysaccharide.

Preferably, the binding agent comprises 0% to 5% of additional ingredients chosen from chelating agent, emulsifier, natural flavour ingredient and enzymes crosslinking modifying the high gel strength protein. More preferably, the binding agent comprises 0.001 wt % or more of one or more of said additional ingredients.

Preferably, the additional ingredient is: a chelating agent chosen from one or more of phosphates or citrates; is a natural flavour ingredient chosen from one or more of arginine, lysine, histidine, yeast extract; is a food grade emulsifiers is chosen from one or more of nonionic, cationic, anionic surfactants such as lecithin; is an enzyme, such as a protein crosslinking enzyme such as transglutaminase that modify characteristics of the high gel strength protein.

Preferably, the plant-based meat substitute according to the invention is a substitute for mammal meat, such as from bovine, swine, sheep; poultry meat, such as from chicken, turkey, duck; aquatic animal meat, such as from fish, crustacean. Even more preferably, the meat substitute is a form comprising particles (i) mimicking ground meat and/or meat particles, and a binding agent (ii).

Preferably, the plant-based meat substitute further comprises one or more of flavoring and coloring additives.

The process for making the plant-based meat substitute according to present invention comprises the following steps: the components are mixed with water, allowed to hydrate, formed to a shape, heated to a temperature of about 70° C. or higher, and cooled. When needed, a pre-emulsion can be used by mixing a new binding system, water and vegetable oil at room temperature and under high shear processing, although this generally is not necessary. The emulsion can be mixed with texturized plant protein material and allow for hydration, followed by the subsequent shaping and heating steps.

Shaping generally is aimed at providing a desired shape, achieved for example by molding, extrusion and the like. Desired shape can be meat-ball shape, burger-shape, fish-finger shape, chicken-nugget shape etc.

### SHORT DESCRIPTION OF THE FIGURES

FIG. 1 shows self-supporting gels obtained from rubisco protein isolate, potato protein isolate (patatin), and canola protein isolate. Protein-water mixtures (1-6% w/w) were heated at 90° C. for 1 hour and immediately observed for self-supporting gels.

FIG. 2 shows gel hardness values of various proteins from plant and animal origins at a range of concentrations, with and without salt.

FIG. 3 shows exemplary test results of a gel measurement.

FIG. 4 shows a data plot between protein solubility and gel hardness of 4% (w/w) aqueous suspensions from 18 protein materials.

FIG. 5 shows a data plot between protein solubility and gel hardness of 4% (w/w) aqueous suspensions in the presence of 1.5% wt from 18 protein materials.

FIG. 6 shows pictures of selected burger patties prepared from new binding agents and methyl cellulose

### DETAILED DESCRIPTION OF THE INVENTION

The combination is used as a substitute for egg white or methylcellulose and its derivatives, which are commonly required as a binding agent in meat analogues of mammals, poultry or other farm animals, fish, crab or other aquatic animals. The meat analogues often comprise texturized protein particles, such as TVP. Such particles resembling ground meat, crab or fish meat, and the like often need to be bound in a larger structure.

The plant-based meat substitute according to the present invention comprises
(i) particles comprising a texturized plant protein material, water and a vegetable lipid and
(ii) a binding agent comprising, relative to the particles and binding agent,
   0.5% to 20% of a high gel strength protein
   0.3% to 20% of a cold-thickening polysaccharide

The term ‘binding agent’ or ‘binder’ as used herein means an agent that mediates binding between single components, e.g. pieces of textured vegetable protein, and stabilizes the formed shapes of meat substitute products, for example, hamburger patty analogues, meat loaf analogues, crab cake analogous, chicken nugget analogues.

### High Gel Strength Proteins

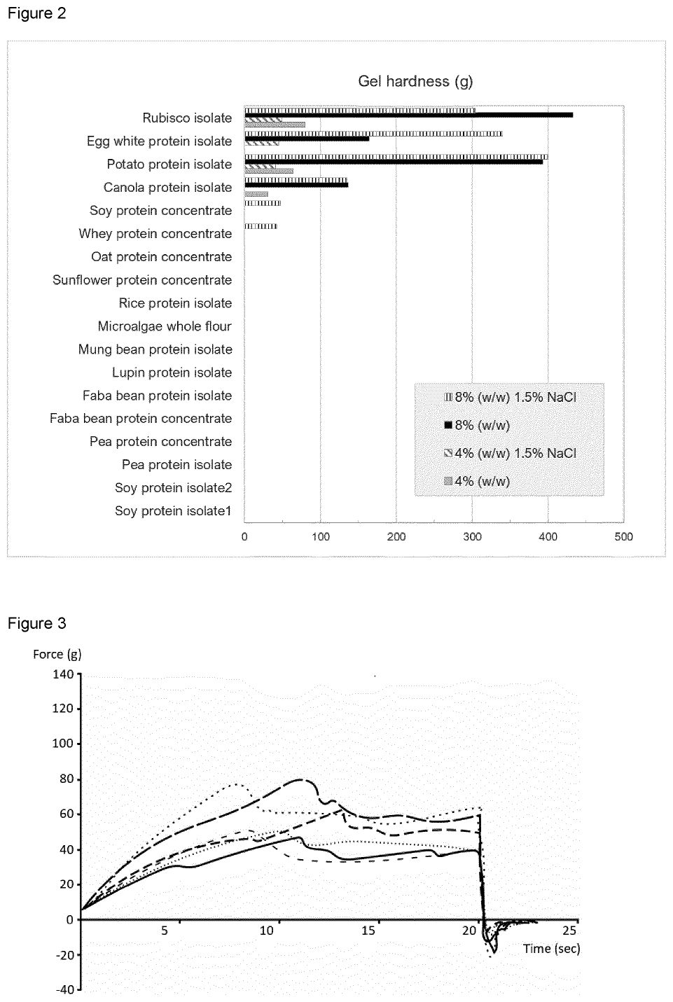

Among eighteen protein materials tested, rubisco protein isolate and potato protein isolate show self-supporting gel formation in water immediately upon heating at 90° C. for 1 h at low concentration 2% and 4% w/w, respectively. Canola protein isolate shows a weak gel at 4% w/w that is easily deformed upon turning the container upside down. This protein shows gel-supporting gel formation in water upon heating at 6% w/w. Other plant protein materials do not show such gel formation even at 8% w/w or at 17% w/w. After incubation at 4° C. for 16 h, the gels of rubisco protein isolate, potato protein isolate and canola protein isolate exhibit the gel hardness values of more than 30 g at 4% w/w in water with or without the presence of 1.5% NaCl. These values are comparable to egg white protein gel in the presence of 1.5% NaCl. Such gel hardness value is not observed for many other protein materials tested as currently available. At 8% w/w, increased gel harness values are observed for rubisco protein isolate, canola protein isolate, potato protein isolate and egg protein powder. These gels exhibit the gel hardness values of more than 100 g. At the same concentration, whey protein concentrate and soy protein concentrate show gel hardness of 40 g, while other plant proteins tested did not exhibit self-supporting gel characteristics (see FIG. 2).

Depending on manufacturers, protein concentrate products contain total protein ranging from 50 to 75% of total weight, whereas protein isolate products contain total protein more than 75% of total weight, most likely 80-95%.

This particular gelation property indicates that some plant protein isolates such as potato, canola or rubisco protein isolates are high gel strength proteins which can form self-supporting gels upon heating at relatively low concentration and exhibit measurable gel hardness values after cold storage. In this invention, the high gel strength proteins possess gel hardness value of at least 30 g and 100 g at 4% w/w and 8% w/w protein, respectively, in water and/or 1.5% NaCl. These proteins exhibit endothermic peak of protein denaturation determined by differential scanning colorimetry (DSC). Such thermal property indicate that these proteins possess native protein structures that are denatured upon heating. A range of denaturation temperature of rubisco protein isolate and potato protein isolate is lower than that of canola protein isolate, indicating that higher temperature is needed to induce gel formation for canola protein isolate.

To achieve efficient heat induced gelation, it is furthermore preferred that the high gel strength protein is well soluble as 2 wt % protein in water, and in 1.5 wt % NaCl solution (at about pH 7). Therefore, the solubility of protein in water and in 1.5 wt % NaCl in water preferably is 40% or more, more preferably 50% or more. For example, generally available food grades of pea protein isolate or soy protein isolate as well as other tested plant protein materials show lower solubility, such as between 10-30%. These protein materials do not exhibit gel hardness value at 4% w/w in water and in 1.5% wt% (solubilities are shown in FIG. 3, 4).

Rubisco (ribulose-1,5-bisphosphate carboxylase-oxygenase) is one of the most abundant plant proteins on the earth. It is the enzyme involved in the photosynthetic fixation of carbon dioxide. This enzyme can be isolated from various plants and algae, and procedures for its isolation and purification have been disclosed, for instance in WO 2021/007484 and WO 2021/015087. U.S. Pat. No. 10,863,761 discloses the composition of a beef meat replica comprising a heme-containing protein. In the present invention, rubisco protein isolate obtained from Lemna or Lemnoideae, commonly known as duckweeds, water lentils or water lenses, is the most effective high gel strength protein.

The high gel strength protein material preferably contains native rubisco protein more than 50% or more, preferably more than 70% of the total weight, and even more preferably about 90 wt % or more.

Rubisco has beneficial effects in meat replicas such as high solubility, close to optimum essential amino acid composition and ability to interact with lipids.

Patent application AU2021240241 discloses composition of an isolated and purified plant protein for application of as a meat substitute that is constructed from a muscle analog, fat analog and connective tissue analog, where rubisco is employed to modulate melting properties and fat retention of a fat analog.

In addition to its technical/functional property, rubisco protein is a sustainable source of essential amino acids similar to those of egg white, potato and soy proteins which are superior to proteins from pea and other plant sources.

Patatin is a storage protein in potato tuber that has a lipase activity. It causes hydrolysis of phospholipids, monoglycerides and triglycerides with short chain fatty acids. Coconut oil and palm kernel oil, commonly used in a preparation of meat substitutes, contain high amount of short chain fatty acids than other vegetable oils. Hydrolysis of these oils by potato patatin may generate a high amount of free fatty acids which may develop off-flavour in meat substitute products. In this regard, rubisco protein is preferred to potato patatin.

Other high gel strength proteins may be derived through manufacturing methods such as mild extraction of plant proteins preserving more native protein structures, extraction of soluble proteins from single cells such as microalgae and through fermentation of yeasts.

In its pure, commercially available form, rubisco protein, potato protein or canola protein for example, generally are available as colorless or brownish or yellowish or off-white and neutral taste powder. Like methylcellulose the viscosity of the high gel proteins increases upon heating, but, unlike the gelling of methylcellulose, this denaturation is irreversible, what is a further advantage of the binding agents of the present disclosure, when compared to the prior art. Moreover, by adding a protein instead of methylcellulose to the meat imitation, the nutritional value of said meat substitute is enhanced, especially the high gel strength protein having high amount of essential amino acid, such as rubisco and potato proteins.

### Cold Thickening Polysaccharide

The cold thickening polysaccharide provides cold adhesiveness to protein mass and other ingredients at room temperature before cooking, useful for shape formation. The cold thickening polysaccharide component of the binding agent comprises of food-grade polysaccharides that are fully or partially disperse in water, generating a viscous aqueous mixture at room temperature.

The cold thickening polysaccharide in the plant-based meat substitute is food substance that is completely or partially soluble in water at room temperature (20-30° C.) with or without shearing process, and their water mixtures possess high viscosity without heat pretreatment. Alternative to methylcellulose, this cold thickening polysaccharide provides viscous water-based liquid, enabling shaping or molding a hydrated mixture of TVP particles and other ingredients to desired shapes prior to heating step.

In a preferred embodiment of the present invention, the cold-thickening polysaccharide is pregelatinized starch. Pregelatinized starch is an instant starch that has been pre-gelatinized in water and then dried. During the pre-gelatinization process, hydrogen bonds between individual starch molecules are partially replaced by water-starch hydrogen bonds, what results in a weakening of the bonding between starch molecules. Pregelatinized starch is a partially solubilized starch with better room temperature solubility than native starch. It subsequently swells in liquid without the application of heat. Due to this ability, it forms a viscous paste in cold water. Because pregelatinized starch is physically processed without the use of any chemicals, it is used as clean-label, E-number free, thickening agent or fat substitute in many foods, including instant pudding mixes, baby food, soups and desserts

Cold water-swelling (CWS) starch is another clean-label instant starch that is physically modified to hydrates and swells instantly without heating and produces the functional properties of fully gelatinized starch. It offers convenience, stability, clarity, and texture. They may be used in cold-process salad dressings, providing the thick, creamy mouth feel in non-fat salad dressings.

Both pregelatinized and cold water-swelling starches enhances the viscosity of meat surrogate mixtures already at ambient temperature, and thus enables the shaping of such products prior to heating.

In the present invention, pregelatinized pea starch is particularly preferred. Other suitable pregelatinized or cold water-swelling starches include starches from potato, wheat, spelt, com, sago, tapioca, rice, barley, rye, triticale, quinoa, amaranth, teff, sweet potato, mung bean, yam, edible canna, arrow root or banana. Starch can be normal or waxy type.

Alternatively, other typical, food-compatible, plant-based food substances may also be used as the cold thickening polysaccharide in the present invention. Such food substances include plant fiber materials, such as instant oatmeal, wheat fiber, psyllium husk fiber, citrus fiber; maltodextrins with low dextrose equivalent, and partially or completely soluble fibers or gums, such as beta-glucan, arabinoxylan, xyloglucan, pectin, xanthan gum, guar gum, konjac glucomannan, gum tragacanth, carrageenan, gellan gum, scleroglucan, locust bean gum, alginate.

Of these alternatives, instant oatmeal, psyllium husk fiber, beta-glucan, pectin are preferred.

### Other Components Influencing Binding Properties

Preferably, the binding agent comprises 0% to 5% of additional ingredients chosen from chelating agent, emulsifier, natural flavour ingredient and enzymes crosslinking modifying the high gel strength protein. More preferably, the binding agent comprises 0.001 wt % or more of one or more of said additional ingredients.

It has been found that the addition of certain food ingredients such as phosphates, citrates and certain natural flavouring agents improve binding properties of the high gel strength protein and cold thickening polysaccharides systems.

The presence of phosphates, citrates or other food grade chelating agents such as EDTA chelate some cations or minerals in the food matrix and are thought to hereby thereby reduce ionic interference to protein gelation, resulting protein gel that are more elastic. This effect improves mouthfeel and texture of the final product.

The presence of certain natural flavouring agents such as yeast extract and basic amino acids (arginine, lysine and histidine) also improve texture profile of the binding system. This is thought to be due to the basic amino acids creating a more uniform and porous gel matrix that can better entrap water or facilitate protein cross-linking.

Suitable enzymes can be used to improve binding ability of high gel strength protein include a protein crosslinking enzyme such as transglutaminase that increase the molecular weight of the protein.

The present inventors found for example that adding mixtures of high gel strength protein and pregelatinized starch in a ratio of 0,5-8:1, more preferable 1-5:1 (preferably 2 wt % to 8 wt % of protein and 1 wt % to 3 wt % of pregelatinized starch) to a representative plant-based meat imitation caused an increase of integrity, improvement of processability, and response to heating equivalent to the addition of 1 to 2 wt % of methylcellulose.

### Particles Comprising a Texturized Plant Protein Material, Water and a Vegetable Lipid

The texturized plant protein products may be aimed to be suitable as red meat analogue (including bovine, porcine, sheep; game like hare deer; tuna fish). Other texturized plant proteins may be more aimed at white meat, such as poultry, white fish, crab and the like.

The term “meat substitutes” or “meat surrogates” can be used interchangeably. They refer to products comprising protein of non-animal origin and produce a meat-like texture. Proteins can be derived from different sources, like legumes, cereals, nuts, mushrooms, algae, bacteria, but are not limited to those.

Texturized plant proteins are known in the industry. Reference can be made to McClements and Grossmann in Compr. Rev. Food Sci. Food Safety 2021 20:4049-4100 and Kyriakopoulou et al., in Functionality of Ingredients and Additives in Plant-based Meat Analogues, Foods 2021, 10, 600. Patent disclosures, suitable as general background include WO2014/193547, US2020/060209, WO2005/004625, WO2003/061400, EP-A-2945490 and US2018/084815. It is noted that some of the older references use partly non-vegan materials. However, nowadays, the same technology is used to make fully vegan fibrous materials.

Preferably, the plant-based meat substitute comprises particles (i) comprising 10 wt % to 60 wt % of texturized plant protein material, 10% to 90% of water and 1% to 30% of a vegetable lipid, wherein the wt % are related to the plant-based meat substitute (amounts of (i) and (ii)). The texturized plant protein material may comprise non-protein compounds, including one or more of alginates, fibrous carbohydrates, triglycerides, water, salt, emulsifiers and the like.

### Processing

The process for making the plant-based meat substitute according to present invention comprises the following steps: the components are mixed with water, allowed to hydrate, formed to a shape, heated to a temperature of about 70° C. or higher, and cooled.

Components may be individually hydrated, or combined in dry state before hydrating. Generally, the mixtures are mixed by agitation during hydration.

In a preferred embodiment, all components are mixed before adding water and allowing to hydrate, as this is the simplest way of preparing the mixtures. If needed, a pre-emulsion can be also prepared by mixing the binding components, water and vegetable oil at room temperature and under high shear processing. The emulsion can be mixed with texturized plant protein material and allow for hydration, followed by the subsequent shaping and heating steps.

### Hardness and Gel Strength

The term “hardness” as used herein refers to a texture parameter of a food and is calculated from the end point of the first compression of the food in a compression assay employing suitable measuring devices, as e.g. a Texture Analyzer (TA.XT. plus, Stable Micro Systems) or a similar. Hardness value is used to determine gel strength of the protein. The test mode was according to normal instructions, in compression mode; test speed 0.50 mm/s; distance 10 mm, trigger force was 5 g on a 10 ml gel sample using a cylindrical probe (0.5″ diameter, Delrin®, part code P/0,5). The end point is measured at 20 sec (see for example results in FIG. 3).

The detected force is believed to correlate with the force required to compress the food between molars during mastication. Variables used herein to adjust the hardness of a meat-substitute are focused on concentrations and ratios of binding materials employed.

### EXAMPLES

### Gel Hardness Values of High Gel Strength Proteins

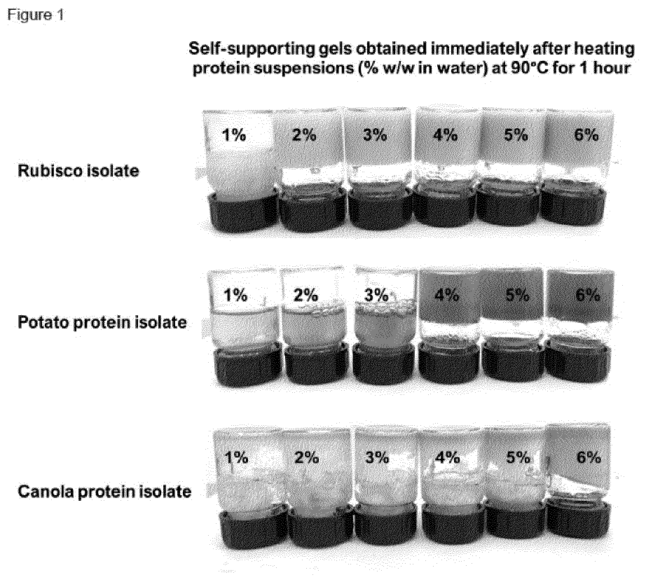

A formation of self-supporting gels upon heating the protein-water mixture at 90° C. for 1 h were qualitatively evaluated for 18 protein materials. Rubisco protein isolate was the most effective gelling proteins, having the least gelling concentration at 2% w/w (see FIG. 1). The lowest gelling temperature of rubisco protein isolate was around 60° C. The self-supporting gels were observed for potato and canola proteins at higher concentration, 4 and 6%, respectively. Other protein materials tested did not form such self-supporting gels even at higher concentration of 8% w/w or higher.

Hardness was tested for 18 protein materials with and without the presence of 1.5 wt % sodium chloride. Protein gels were prepared by heating protein suspensions at 90° C. for 1 hour and stored at 4° C. for 16 hours without turning the container upside down. The pH values of the protein suspensions are in the range of 6.5 to 7.5. Gel hardness was measured as force (g) at the end point of gel strength measurement, as described above. Total protein contents were 4 and 8 wt %. The results are provided in FIG. 2, and exemplary gel hardness tests are shown in FIG. 3. In FIG. 3, the peak in the measurement indicates the rupture force [g], while the force at the end of the measurement represents the hardness [g].

Rubisco protein isolate showed the highest gel firmness value at 4% w/w in water, followed by potato and canola protein isolates. These proteins had gel hardness values of more than 30 g at this condition. Other protein materials did not show gel upon heating at this concentration, therefore gel hardness could not be determined for the other protein materials. At 4% w/w in water with the presence of 1.5 wt % sodium chloride, the gel firmness values of rubisco protein isolate and potato protein isolate were more than 30 g which were comparable to that of egg white protein (see FIG. 2). At 8% w/w, increased gel hardness values were observed for rubisco protein isolate, potato protein isolate, canola protein isolate. At this concentration, weak gel hardness values were also observed for soy and pea protein concentrates. Other plant protein materials, however, did not show self-supporting gel and gel hardness could not be determined.

Accordingly, among several protein materials tested, rubisco protein isolate, potato protein isolate and canola protein isolate are unique for their high gel strength measured as hardness value more than 30 g at 4 wt % in water with or without the presence of 1.5 wt % sodium chloride. Rubisco protein isolate was the most effective high gel strength protein at low protein concentration.

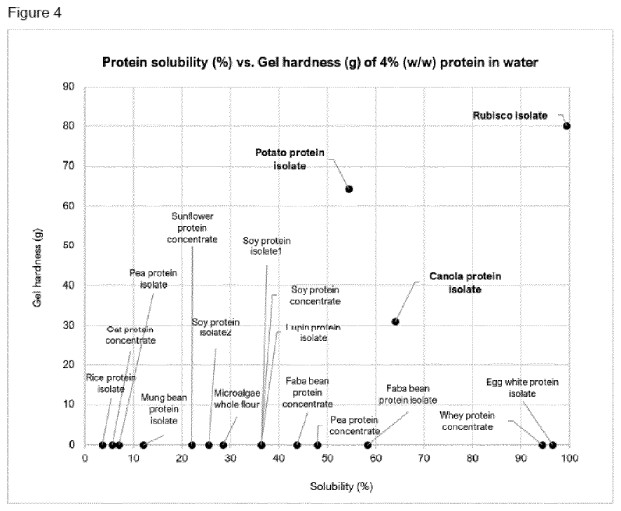

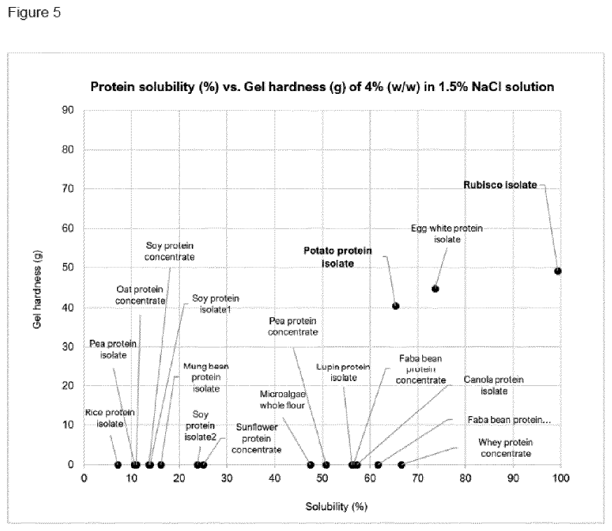

The high gel strength proteins described above have protein solubility (2% w/w suspension in water or 1.5% NaCl, at room temperature) higher than 40%, in which rubisco has the highest solubility higher than 90%. It is noted that not all proteins having solubility greater than 50% are high gel strength proteins, and none of the proteins having solubility lower than 50% can form self-supporting gel upon heating (see also FIG. 4, FIG. 5).

In this invention, the high gel strength proteins are protein materials possessing the gel hardness of at least 30 g at 4 wt % in water or in 1.5 wt % NaCl in water; preferably at 4 wt % in water and in 1.5 wt % NaCl in water, and possess solubility more than 40%, more preferably 50%, at 2% w/w in water or in water with the presence of 1.5 wt % sodium chloride.

### Cold Thickening Polysaccharide

In this invention, pre-gelatinized starch, cold-water swelling starch, psyllium husk fiber, instant oatmeal, beta-glucan, pectin and xyloglucan are preferred food substances for use as cold thickening polysaccharide. These substances are used at 0.5-6% in the plant-based meat substitute, providing comparable viscosity values to methylcellulose at 1%, i.e. viscosity value more than 100 centipoise (cP) measured using Rapid Visco Analyzer® at 30° C., 180 rpm, 20 min.

### Examples 1-4, Comparative Experiments A, B

### Method of Preparing Vegan Burger Analogue and Analysis Thereof

Water was added to textured vegetable protein (TVP) from soy, pea or other sources in a mixture and stirred until properly hydrated. Coconut oil and other components (salt, coloring, flavouring agents) were added to the hydrated texture pea protein. Binding agent, e.g. methylcellulose (pre-dissolved in cold water or pre-emulsion with coconut oil and cold water) or egg white powder or a dry mix of a high gel strength protein and cold thickening agent, was added to the mixture. The mixture so obtained was slowly mixed to obtain a final mixture that is adhesive and homogenous. About 100 g of final mixture was molded by hand or in a mold to a round shape which assembles a burger patty shape.

The patty shaped mixture was cooked immediately by searing both sides in a pan or griller, or by heating at 160-180C in an oven until both sides were fully cooked. Alternatively, the patty shaped mixture was stored at 4° C. overnight before cooking.

Basically, the patty shaped mixture is measured for hardness using Texture Analyzer at different phase. The mixtures were kept at 10° C. for 30 min, and their hardness was then measured with a texture analyzer (TA.XT. plus, Stable Micro Systems, compression mode at test speed 0.50 mm/s; distance 5 mm and a trigger force of 5.0 g on a 55 g sample using a cylindrical probe (0.25 mm diameter, aluminum, part code P/25)). The mixtures where then heated to 80° C. for 10 min, then to 90° C. for 5 min, then allowed to cool to room temperature (20° C.) in 60 min, then reheated to 50° C. for 10 min, to 60° C. for 5 min, and finally to 70° C. for 5 min. After each heating period the hardness was again measured. The results are given in the table below. All the measured hardness values are in N/m².

### Specific Meat Substitutes

A number of different meat substitutes were prepared by mixing the pea-protein-based meat imitation TVP, such as for example Rovitaris PX 365 available from BK Giulini GmbH, with water and liquid coconut fat, and adding to this mixture at room temperature either 1% or 2% of methylcellulose (pre-dissolved in cold water; 4000 cps) or various amounts of potato protein (patatin) and pregelatinized pea starch, as specified in the table below. All numbers are weight-%.

| | | | | | C. | C. |
|---|---|---|---|---|---|---|
| Ingredients [%] | Ex. 1 | Ex. 2 | Ex. 3 | Ex. 4 | Exp A | Exp B |
| TVP | 28.75 | 28.44 | 28.13 | 27.81 | 23.44 | 23.44 |
| Water | 61.25 | 59.56 | 58.87 | 57.19 | 51.56 | 51.56 |
| coconut fat (I) | 5 | 5 | 5 | 5 | 5 | 5 |
| pregel. pea starch | 1 | 1 | 1 | 1 | 0 | 0 |
| Potato protein | 4 | 6 | 7 | 9 | 0 | 0 |
| Methyl cellulose | 0 | 0 | 0 | 0 | 1 | 2 |
| Water/Ice | 0 | 0 | 10 | 0 | 19 | 18 |

The hardness results are summarized in the below table.

| Hardness (TxA., g) | Ex. 1 | Ex. 2 | Ex. 3 | Ex. 4 | C. Exp. A | C. Exp. B |
|---|---|---|---|---|---|---|
| 80° C. | 1023 | 1223 | 1535 | 1327 | 894 | 1036 |
| St. Dev. [%] | 13 | 16 | 11 | 34 | 9 | 8 |
| 90° C. | 667 | 855 | 1137 | 1171 | 730 | 871 |
| St. Dev. [%] | 5 | 6 | 8 | 5 | 5 | 18 |
| 10° C. | 1576 | 1639 | 2531 | 2356 | 723 | 1027 |
| St. Dev. [%] | 16 | 9 | 12 | 8 | 6 | 10 |
| ReHe 70° C. | 896 | 1162 | 1373 | 1047 | 785 | 1052 |
| St. Dev. [%] | 14 | 9 | 8 | 23 | 8 | 16 |
| ReHe 60° C. | 923 | 729 | 1106 | 1687 | 755 | 883 |
| St. Dev. [%] | 10 | 24 | 35 | 15 | 17 | 13 |
| ReHe 50° C. | 721 | 886 | 1237 | 1401 | 813 | 1089 |
| St. Dev. [%] | 28 | 15 | 22 | 26 | 15 | 14 |

These results show that for instance Example 2 (6% potato protein, 1% pregelatinized pea starch) closely resembles the control mixtures with methylcellulose (Comp Exp. A and B).

### Examples 5-6 and Experiments I-III

In some formulation, high salt (1-3% NaCl) is added to a meat analogue. These amounts of salt reduce the solubility of a number of plant proteins, and/or reduce the gel strength obtained by the protein. Yet, the compositions of the present invention still provide suitable strength.

This example furthermore shows that the addition of TSPP (tetrasodium pyrophosphate) 0.1% (or other polyphosphates or phosphate types) for recipes containing high salt concentration improves the gel strength. The addition of TSPP or other phosphates retains high hot binding ability of the binding agent (hot binding and cold binding agent).

In a first set of experiments, the gel strength of protein gels was determined.

| Ingredients [%] | Exp. I | Exp. II | Exp. III |
|---|---|---|---|
| Potato protein* | 7 | 7 | 7 |
| Sodium chloride | 0.1 | | |
| TSPP | | | 0.1 |
| Water | 92.9 | 93 | 92.9 |
| | Firmness of gel | | |
| | 45.3 g | 59.5 g | 68.5 g |
| St dev | 6% | 4% | 6% |

*The batch of potato protein was of relatively low quality, the firmness-of-gel values normally are higher for potato protein in the used amounts. Nevertheless, the trend in firmness due to the addition of salt/TSPP is representative.

Patties were prepared as described above with the ingredients as given in the next table.

| Ingredients [%] | Ex. 5 | Ex. 6 |
|---|---|---|
| TVP | 26.8 | 26.8 |
| Water | 58.2 | 58.1 |
| coconut fat (I) | 5.0 | 5.0 |
| pregel. Pea starch | 1.0 | 1.0 |
| Canola protein | 8 | 8 |
| Sodium chloride | 1.0 | 1.0 |
| TSPP | 0 | 0.1 |

Hardness

| | | |
|---|---|---|
| | 2131 g | 2932 g |
| St dev | 15% | 19% |

The results showed that addition of TSPP increase hardness of burger in the presence of salt, but also without additional salt present.

### Examples 7-11

In a similar process as described for the former products, in addition to TSPP or phosphates, the presence of basic amino acid (Lysine, Arginine, Histidine), yeast extract, food grade surfactants (e.g. lecithin (from soy or sunflower), mono- or diglycerides etc.), or enzymes that modify protein structures e.g. transglutaminase (for cross-linking) can enhance or modify protein gel strength and elasticity. In particular, addition of these ingredients will improve textural properties such as hardness, softness, water retention, juiciness and taste of final product as they modify intermolecular interaction of protein leading better or enhance hot-binding property of a high gel strength protein.

| Ingredients [%] | Ex. 7 | Ex. 8 | Ex. 9 | Ex. 10 | Ex. 11 |
|---|---|---|---|---|---|
| TVP | 28.5 | 28.3 | 28.5 | 28.5 | 28.5 |
| Water | 62.2 | 61.2 | 62.2 | 61.4 | 62.2 |
| coconut fat (I) | 5.0 | 5.0 | 5.0 | 5.0 | 5.0 |
| pregel. Pea starch | 1 | 1.5 | 1 | 2 | 1 |
| High gel strength protein | 3 | 3 | 3 | 3 | 3 |
| Basic amino acid (Lys) | 0.3 | | | | |
| Yeast extract | | 1.0 | | | |
| Surfactant (lecithin) | | | 0.3 | | |
| Enzyme (transglutaminase) | | | | 0.1 | |
| Sodium Polyphosphate | | | | | 0.3 |

### Example 12

In this example, white color texturized protein material (TVP) was used, like for example available from BK Giulini GmbH and its affiliates under the trade name Rovitaris® Fibers or Rovitaris® PF1000 series. This protein material is texturized by alginate agglomeration, using calcium ions, and is generally denoted as high moisture texturates. Other texturized protein material, such as TVP obtained from high moisture extrusion processing, can be used as well.

### Example 13

In this example, combinations of the white color TVP and the new binding system are shown to be suitable for producing desired forms and textures of vegan imitations of nuggets, fish-fingers and the like. A number of different formulations were prepared by mixing the white TVP at desired particle size, such as for example Rovitaris® PF1000, with a mixture of water, oil, flavourings and either 1% or 2% of methylcellulose (pre-dissolved in cold water) or a binding agent comprising a high gel strength protein (3% or 4% rubisco protein isolates or 4% or 6% potato protein isolates) and a cold-thickening polysaccharide (1% or 2% pregelatinized starch or 1% or 2% psyllium husk fiber, or their mixtures). The mass was pressed into suitable shape (e.g. nugget or fish finger), battered and breaded, frozen and then deep-fried before consumption until internal temperature was over 70° C. Results showed that a coherent product with the new binding system could mimic the texture of methylcellulose based vegan nugget and comparable to that of a conventional non-vegan chicken nugget; e.g. the combination of high gel-strength protein (3% Rubisco or 5% potato protein or 8% canola protein) and 1.5% pregelatinized pea starch or 1% psyllium husk fiber led to a favourable end-product shapes with a firm bite after cooking, and was also tase-wise well perceived by a sensory panel.

### Example 14-18

A number of different plant-based burger patties were prepared by mixing the pea-protein-based TVP, such as for example Rovitaris PX 365 available from BK Giulini GmbH, with water and liquid coconut fat, and adding to this mixture at room temperature with various amounts of rubisco protein isolate and pregelatinized pea starch, as specified in the table below. All numbers are weight-%.

| Ingredients [%] | Ex. 14 | Ex. 15 | Ex. 16 | Ex. 17 | Ex. 18 |
|---|---|---|---|---|---|
| TVP | 28.37 | 28.6 | 27.95 | 27.64 | 28.27 |
| Water | 63.63 | 62.4 | 62.05 | 61.36 | 59.73 |
| coconut fat (I) | 5 | 5 | 5 | 5 | 5 |
| pregel. pea starch | 1 | 1 | 1 | 1 | 1 |
| Rubisco protein | 2 | 3 | 4 | 5 | 6 |

Hardness (g)

| | | | | | |
|---|---|---|---|---|---|
| 80° C. | 1056 | 1260 | 1492 | 1706 | 1953 |
| St. Dev. [%] | 8 | 21 | 18 | 7 | 24 |
| 90° C. | 742 | 865 | 1124 | 1498 | 1507 |
| St. Dev. [%] | 6 | 9 | 11 | 7 | 8 |
| 10° C. | 1576 | 1701 | 1981 | 2413 | 2861 |
| St. Dev. [%] | 7 | 15 | 12 | 11 | 28 |
| ReHe 70° C. | 863 | 1244 | 1313 | 1492 | 1639 |
| St. Dev. [%] | 25 | 13 | 25 | 16 | 12 |
| ReHe 60° C. | 893 | 1283 | 1396 | 1543 | 1749 |
| St. Dev. [%] | 32 | 8 | 19 | 8 | 11 |
| ReHe 50° C. | 911 | 1152 | 1501 | 1581 | 1631 |
| St. Dev. [%] | 19 | 23 | 14 | 24 | 18 |

These results show that for instance Example 14, 15 and 16 (2%, 3% and 4% Rubisco protein, 1% pregelatinized pea starch) closely resembles the control mixtures with methylcellulose (Comp Exp. A and B).

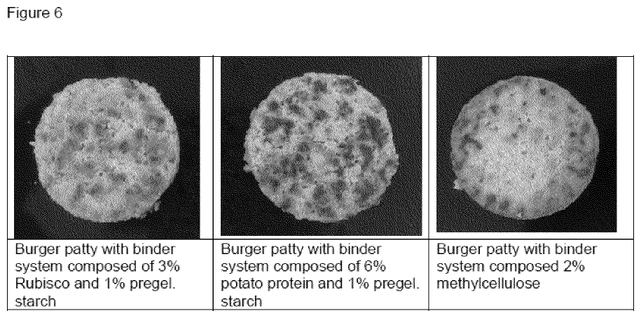

In addition, all meat substitutes prepared according to compositions described in the table above, replacing methylcellulose as a new binder, were perceived by a trained sensory panel to have texture, taste and visual appearance comparable to burger patties employing methylcellulose. Pictures of selected burger patties are depicted in FIG. 6.

### Example 19-22, Comparative Experiments C, D

In a similar process as described for the former products, crab cake imitations were prepared by mixing white color TVP with water and liquid coconut fat, salt, seasonings and adding to this mixture at room temperature with various amounts of rubisco protein and pregelatinized pea starch or psyllium husk fiber, as specified in the table below. All numbers are weight-%. This example furthermore shows that the addition of TSPP (tetrasodium pyrophosphate) 0.1% (or other polyphosphates or phosphate types) improves the gel strength. The addition of TSPP or other phosphates retains high hot binding ability of the binding agent (hot binding and cold binding agent).

In a first set of experiments, the gel strength of protein gels was determined.

| | | | | | C. | C. |
|---|---|---|---|---|---|---|
| Ingredients [%] | Ex. 19 | Ex. 20 | Ex. 21 | Ex. 22 | Exp. C | Exp. D |
| White color TVP | 28.86 | 27.94 | 28.11 | 28.74 | 27.98 | 28.62 |
| Water | 56.64 | 57.46 | 58.09 | 57.36 | 60.52 | 58.88 |
| coconut fat (I) | 5 | 5 | 5 | 5 | 5 | 5 |
| Salt | 2 | 2 | 2 | 2 | 2 | 2 |
| Seasonings | 3.5 | 3.5 | 3.5 | 3.5 | 3.5 | 3.5 |
| pregel. pea | 1 | 1 | 0 | 0 | 0 | 0 |
| starch | | | | | | |
| psyllium husk | 0 | 0 | 0.3 | 0.3 | 0 | 0 |
| fiber | | | | | | |
| Rubisco protein | 3 | 3 | 3 | 3 | 0 | 0 |
| methyl cellulose | 0 | 0 | 0 | 0 | 1 | 2 |
| TSPP | 0 | 0.1 | 0 | 0.1 | 0 | 0 |

Hardness (g)

| | | | | | | |
|---|---|---|---|---|---|---|
| 80° C. | 1072 | 1227 | 1187 | 1297 | 892 | 1108 |
| St. Dev. [%] | 15 | 7 | 18 | 9 | 7 | 6 |
| 90° C. | 761 | 823 | 852 | 1002 | 801 | 988 |
| St. Dev. [%] | 10 | 12 | 9 | 8 | 18 | 7 |
| 10° C. | 1461 | 1734 | 1834 | 2274 | 738 | 981 |
| St. Dev. [%] | 8 | 16 | 11 | 21 | 6 | 16 |

These results show that the binding agent comprising rubisco protein isolate as high gel strength protein and pregelatinized pea starch or psyllium husk fiber as cold thickening polysaccharide provided hot and cold binding ability closely resembles to methylcellulose (Comp Exp. C and D).

1. A plant-based meat substitute comprising
(i) particles comprising a texturized plant protein material, water and a vegetable lipid and
(ii) a binding agent comprising, relative to the particles and binding agent,
0.5% to 20% of a high gel strength protein
0.3% to 20% of a cold-thickening polysaccharide.

2. The plant based meat substitute according to claim 1, wherein the binding agent comprises 0% to 5% of additional ingredients chosen from chelating agent, emulsifier, natural flavour ingredients and enzymes crosslinking modifying the high gel strength protein, preferably, 0.001 wt % or more of one or more of said additional ingredients.

3. The plant-based meat substitute according to any one of claims 1-2, wherein the particles (i) comprise 10 wt % to 60 wt % of texturized plant protein material, 10% to 90% of water and 1% to 30% of a vegetable lipid, wherein the wt % are related to the plant-based meat substitute.

4. The plant-based meat substitute according to any one of claims 1-3, wherein the binding agent comprises 0.5-8% of a high gel strength protein and 0.3-4% of a cold-thickening polysaccharide.

5. The plant-based meat substitute according to any one of claims 1-4, wherein the high gel strength protein possesses gel hardness values >30 g at 4 wt % in water or in 1.5 wt % NaCl in water preferably at 4 wt % in water and in 1.5 wt % NaCl in water.

6. The plant-based meat substitute according to any one of claims 1-5, wherein the high gel strength protein exhibits a solubility of about 40% or more, preferably 50% or more, as 2 wt % protein mixture in water, and in 1.5 wt % NaCl solution, at a pH of about 7.

7. The plant-based meat substitute according to any one of claims 1-6, wherein the high gel strength protein forms a self-supporting gel at 4% w/w in water at temperatures lower than 70° C.

8. The plant-based meat substitute according to any one of claims 1-7, wherein the high gel strength protein is rubisco protein.

9. The plant-based meat substitute according to any one of claims 1-8, wherein the high gel strength protein is potato protein.

10. The plant-based meat substitute according to any one of claims 1-9, wherein the cold thickening polysaccharide is physically modified starches such as pregelatinized starch, cold water-swelling starch, or their mixture.

11. The plant-based meat substitute according to claim 10, wherein the cold thickening polysaccharide is pregelatinized starch, preferably pea starch.

12. The plant-based meat substitute according to any one of claims 1-11, wherein the cold thickening polysaccharide is plant fiber material, such as psyllium husk fiber, instant oatmeal, wheat fiber, or their mixture.

13. The plant-based meat substitute according to any one of claims 1-12, wherein the cold thickening polysaccharide is soluble fiber such as beta-glucan, arabinoxylan, xyloglucan, pectin, or their mixture.

14. The plant-based meat substitute according to any one of claims 1-13, wherein the cold thickening polysaccharide is hydrocolloid gum such as xanthan gum, guar gum, konjac glucomannan, gum tragacanth, curdlan, carrageenan, gellan gum, scleroglucan, locust bean gum, alginate, or their mixture.

15. The plant-based meat substitute according to any one of claims 1-14, wherein the chelating agent is chosen from one or more of phosphates or citrate.

16. The plant-based meat substitute according to any one of claims 1-15, wherein natural flavour ingredient is chosen from one or more of arginine, lysine, histidine, yeast extract.

17. The plant-based meat substitute according to any one of claims 1-16, wherein food grade emulsifiers is chosen from one or more of nonionic, cationic, anionic surfactants

18. The plant-based meat substitute according to any one of claims 1-17, wherein the enzyme is a protein crosslinking enzyme such as transglutaminase.

19. The plant-based meat substitute according to any one of claims 1-18, wherein the meat substitute is a substitute for mammal meat, such as from bovine, swine, sheep; poultry meat, such as from chicken, turkey, duck; aquatic animal meat, such as from fish, crustacean.

20. The plant-based meat substitute according to claim 19, wherein the meat substitute is a form comprising particles (i) mimicking ground meat and/or meat particles, and a binding agent (ii), preferably vegan burger patties, meatballs, crab cakes, fish fingers, or chicken nuggets.

21. Process for making the plant based meat substitute according to any one of the preceding claims, wherein the components are mixed with water, allowed to hydrate, formed to a shape, heated to a temperature of about 70° C. or higher, and cooled.
